(19) United States
(12) Patent Application Publication
(10) Pub. No.: US 2025/0390652 A1
(43) Pub. Date: Dec. 25, 2025

(54) CIRCUIT DESIGN ASSISTANCE DEVICE, CIRCUIT DESIGN ASSISTANCE METHOD, AND COMPUTER READABLE MEDIUM

(71) Applicant: Mitsubishi Electric Corporation, Tokyo (JP)

(72) Inventor: Koki MURANO, Tokyo (JP)

(73) Assignee: Mitsubishi Electric Corporation, Tokyo (JP)

(21) Appl. No.: 19/306,472

(22) Filed: Aug. 21, 2025

Related U.S. Application Data
(63) Continuation of application No. PCT/JP2023/015387, filed on Apr. 17, 2023.

(51) Int. Cl. G06F 30/323; G06F 119/02

(52) U.S. Cl. CPC G06F 30/323; G06F 2119/02

(57) ABSTRACT

A scheduling unit (110) of a circuit design assistance device (100) acquires a high-level description (61) including a plurality of external memory accesses from a plurality of modules, required circuit performance (63), and external memory information (64). The scheduling unit (110) identifies external memory accesses that operate in parallel in a circuit, and determines an issue order (72) of the external memory accesses that operate in parallel so as to satisfy the required circuit performance (63). A circuit generation unit (120) of the circuit design assistance device (100) generates a circuit description (65) of an external memory access circuit including a scheduler circuit that issues the external memory accesses that operate in parallel in the issue order (72).

### CROSS REFERENCE TO RELATED APPLICATION

This application is a Continuation of PCT International Application No. PCT/JP2023/015387, filed on Apr. 17, 2023, which is hereby expressly incorporated by reference into the present application.

### TECHNICAL FIELD

The present disclosure relates to a circuit design assistance device, a circuit design assistance method, and a circuit design assistance program.

### BACKGROUND ART

With the increasing scale of semiconductor integrated circuits, the development of high-level synthesis technology, which synthesizes circuits using high-level languages with a higher level of abstractness than hardware description languages, is progressing. High-level languages with a higher level of abstractness than hardware description languages include C language, C++ language, SystemC language, and Matlab language. High-level synthesis technology is also referred to as behavioral synthesis technology.

A high-level synthesis tool may have a function of generating a memory access circuit from a description of reads from and writes to array variables by modules. A modules is also known as a function. A memory access circuit is also referred to as a bus interface circuit.

With an existing high-level synthesis tool, when a memory is accessed from a plurality of modules, a memory access circuit is generated for each module, which may result in redundant circuits being generated.

Patent Literature 1 discloses a method for generating an interface circuit that efficiently performs memory accesses by merging or dividing functions. In Patent Literature 1, when a pattern of accesses to array variables by a plurality of modules corresponds to a predetermined specific pattern, functions are merged or divided.

### CITATION LIST

### Patent Literature

Patent Literature 1: JP 2007-323206 A

### SUMMARY OF INVENTION

### Technical Problem

In Patent Literature 1, matching with an access pattern prepared in advance makes it possible to reduce the latency and circuit scale related to memory accesses by a plurality of modules.

On the other hand, in Patent Literature 1, a memory access circuit is generated without considering the performance characteristics of a memory. For example, in an external memory such as a DDR-SDRAM, performance varies greatly depending on the transaction size. Therefore, when using such an external memory, the efficiency of memory usage may decrease depending on the design of an external memory access circuit and a method of arbitrating accesses from a plurality of modules, and desired performance may not be achieved. DDR is an abbreviation for double-data-rate. SDRAM is an abbreviation for synchronous dynamic random access memory.

An object of the present disclosure is to achieve performance closer to required performance by automatically generating a scheduler circuit based on the specifications and performance of an external memory.

### Solution to Problem

A circuit design assistance device according to the present disclosure assists in designing a circuit, and the circuit design assistance device includes
a scheduling unit to identify external memory accesses that operate in parallel in the circuit based on a high-level description describing the circuit in a high-level language and including a plurality of external memory accesses indicating accesses to an external memory from a plurality of modules, required circuit performance, which is required performance of the circuit, and external memory information including specifications and performance of the external memory, and determine an issue order of the external memory accesses that operate in parallel so as to allow performance of the circuit to satisfy the required circuit performance; and
a circuit generation unit to generate a circuit description of an external memory access circuit including a scheduler circuit that issues the external memory accesses that operate in parallel in the issue order.

### Advantageous Effects of Invention

With a circuit design assistance device according to the present disclosure, performance closer to required performance can be achieved by automatically generating a scheduler circuit based on the specifications and performance of an external memory.

### BRIEF DESCRIPTION OF DRAWINGS

FIG. 1 is a diagram illustrating an example of a configuration of a circuit design assistance device according to Embodiment 1.

FIG. 2 is a flowchart illustrating the operation of the circuit design assistance device according to Embodiment 1.

FIG. 3 is a diagram illustrating an example of a high-level description according to Embodiment 1.

FIG. 4 is a diagram illustrating an example of a variable memory access circuit according to Embodiment 1.

FIG. 5 is a diagram illustrating a relationship between a burst length and latency according to Embodiment 1.

FIG. 6 is a diagram illustrating an example of a data flow according to Embodiment 1.

FIG. 7 is a diagram illustrating an example of a scheduling process according to Embodiment 1.

FIG. 8 is a diagram illustrating an example of an external memory access circuit according to Embodiment 1.

FIG. 9 is a diagram illustrating an example of a configuration of the circuit design assistance device according to a variation of Embodiment 1.

FIG. 10 is a diagram illustrating a comparative example of the circuit design assistance device according to Embodiment 1.

### DESCRIPTION OF EMBODIMENTS

This embodiment will be described hereinafter with reference to the drawings. In the drawings, the same or equivalent parts are denoted by the same reference signs.

In the description of the embodiment, description of the same or corresponding parts will be suitably omitted or simplified. Arrows in the drawings mainly indicate flows of data or flows of processing.

### Embodiment 1

### ***Description of Configuration***

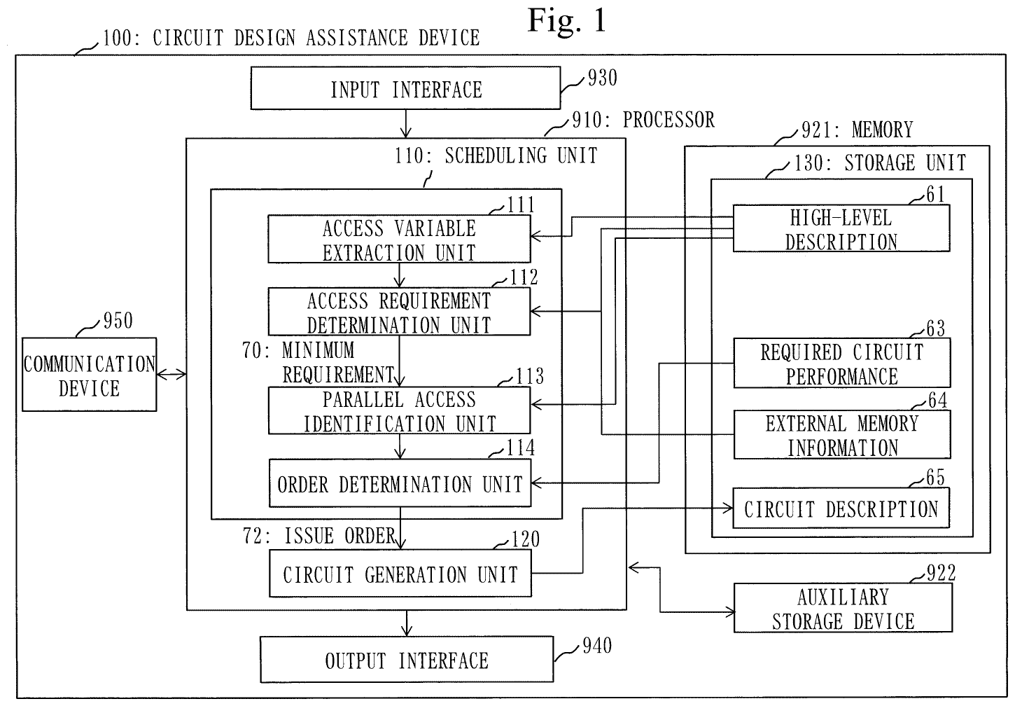

FIG. 1 is a diagram illustrating an example of a configuration of a circuit design assistance device 100 according to this embodiment.

The circuit design assistance device 100 is a device that assists in designing circuits such as semiconductor integrated circuits.

The circuit design assistance device 100 is a computer. The circuit design assistance device 100 includes a processor 910, and also includes other hardware components such as a memory 921, an auxiliary storage device 922, an input interface 930, an output interface 940, and a communication device 950. The processor 910 is connected with other hardware components via signal lines, and controls these other hardware components. The hardware configuration shown in FIG. 1 is an example, and other configurations may be adopted.

The circuit design assistance device 100 includes, as functional elements, a scheduling unit 110, a circuit generation unit 120, and a storage unit 130. The scheduling unit 110 includes an access variable extraction unit 111, an access requirement determination unit 112, a parallel access identification unit 113, and an order determination unit 114. The storage unit 130 stores a high-level description 61, required circuit performance 63, external memory information 64, and a circuit description 65.

The functions of the scheduling unit 110 and the circuit generation unit 120 are realized by software. The storage unit 130 is provided in the memory 921. The storage unit 130 may be provided in the auxiliary storage device 922, or may be divided and provided in the memory 921 and the auxiliary storage device 922.

The processor 910 is a device that executes a circuit design assistance program. The circuit design assistance program is a program that realizes the functions of the scheduling unit 110 and the circuit generation unit 120.

The processor 910 is an IC that performs operational processing. Specific examples of the processor 910 are a CPU, a DSP, and a GPU. IC is an abbreviation for integrated circuit. CPU is an abbreviation for central processing unit. DSP is an abbreviation for digital signal processor. GPU is an abbreviation for graphics processing unit.

The memory 921 is a storage device to temporarily store data. Specific examples of the memory 921 are an SRAM and a DRAM. SRAM is an abbreviation for static random access memory. DRAM is an abbreviation for dynamic random access memory.

The auxiliary storage device 922 is a storage device to store data. A specific example of the auxiliary storage device 922 is an HDD. The auxiliary storage device 922 may be a portable storage medium such as an SD (registered trademark) memory card, CF, a NAND flash, a flexible disk, an optical disc, a compact disc, a Blu-ray (registered trademark) disc, or a DVD. HDD is an abbreviation for hard disk drive. SD (registered trademark) is an abbreviation for Secure Digital. CF is an abbreviation for CompactFlash (registered trademark). DVD is an abbreviation for digital versatile disk.

The input interface 930 is a port to which an input device such as a mouse, a keyboard, or a touch panel is to be connected. Specifically, the input interface 930 is a USB terminal. The input interface 930 may be a port to be connected to a LAN. USB is an abbreviation for Universal Serial Bus. LAN is an abbreviation for local area network.

The output interface 940 is a port to which a cable of an output device such as a display is to be connected. Specifically, the output interface 940 is a USB terminal or an HDMI (registered trademark) terminal. Specifically, the display is an LCD. The output interface 940 is also referred to as a display interface. HDMI (registered trademark) is an abbreviation for High Definition Multimedia Interface. LCD is an abbreviation for liquid crystal display.

The communication device 950 has a receiver and a transmitter. The communication device 950 is connected to a communication network such as a LAN, the Internet, a telephone line, or Wi-Fi (registered trademark). Specifically, the communication device 950 is a communication chip or a NIC. NIC is an abbreviation for network interface card.

The circuit design assistance program is executed in the circuit design assistance device 100. The circuit design assistance program is loaded into the processor 910 and executed by the processor 910. The memory 921 stores not only the circuit design assistance program, but also an OS. OS is an abbreviation for operating system. The processor 910 executes the circuit design assistance program while executing the OS. The circuit design assistance program and the OS may be stored in the auxiliary storage device 922. The circuit design assistance program and the OS that are stored in the auxiliary storage device 922 are loaded into the memory 921 and executed by the processor 910. Part or the entirety of the circuit design assistance program may be embedded in the OS.

The circuit design assistance device 100 may include a plurality of processors as an alternative to the processor 910. These processors share execution of the circuit design assistance program. Each of the processors is a device that executes the circuit design assistance program, like the processor 910.

Data, information, signal values, and variable values that are used, processed, or output by the circuit design assistance program are stored in the memory 921 or the auxiliary storage device 922, or stored in registers or a cache memory within the processor 910.

“Unit” in each of the scheduling unit 110 and the circuit generation unit 120 may be interpreted as “circuit”, “step”, “procedure”, “process”, or “circuitry”. The circuit design assistance program causes a computer to execute a scheduling process and a circuit generation process. “Process” in each of the scheduling process and the circuit generation process may be interpreted as “program”, “program product”, “computer readable storage medium storing a program”, or “computer readable recording medium recording a program”. A circuit design assistance method is a method performed by execution of the circuit design assistance program by the circuit design assistance device 100.

The circuit design assistance program may be stored and provided in a computer readable recording medium. Alternatively, the circuit design assistance program may be provided as a program product.

### ***Description of Operation***

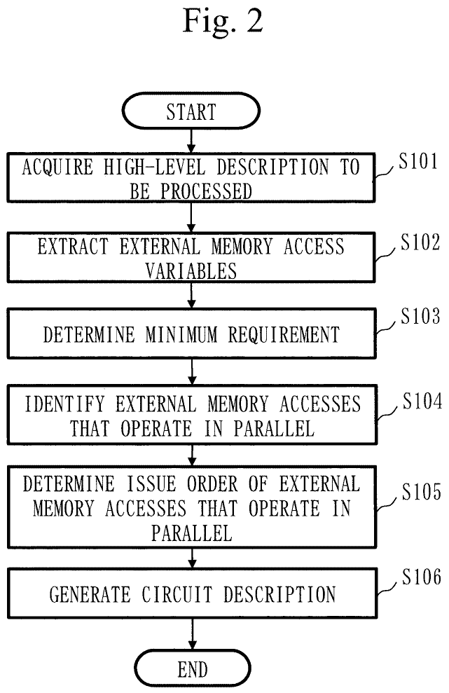

FIG. 2 is a flowchart illustrating the operation of the circuit design assistance device 100 according to this embodiment.

The operation of the circuit design assistance device 100 according to this embodiment will be described. A procedure for the operation of the circuit design assistance device 100 is equivalent to the circuit design assistance method. A program that realizes the operation of the circuit design assistance device 100 is equivalent to the circuit design assistance program that executes a circuit design assistance process.

### <Scheduling Process: Step S101 to Step S105>

The scheduling unit 110 acquires the high-level description 61, the required circuit performance 63, and the external memory information 64. Based on the high-level description 61, the required circuit performance 63, and the external memory information 64, the scheduling unit 110 identifies external memory accesses that operate in parallel in a circuit. Then, the scheduling unit 110 determines an issue order 72 of the external memory accesses that operate in parallel so that the circuit satisfies the required circuit performance 63.

The high-level description 61 is a circuit description that describes a circuit to be designed in a high-level language. The high-level description 61 includes a plurality of external memory accesses indicating accesses to an external memory from a plurality of modules.

The required circuit performance 63 is the required performance of overall processing in the circuit to be designed.

The external memory information 64 is information including the specifications and performance of the external memory.

Specifically, the scheduling process involves the following.

In step S101, the access variable extraction unit 111 acquires the high-level description 61 to be processed. The high-level description 61 is a circuit operation description in a high-level language such as C language, C++ language, SystemC language, or Matlab language. In the high-level description 61, processing is defined as modules. A module is a function. The high-level description 61 is written in such a way that variables corresponding to the external memory can be specified by a directive such as pragma or a separate input file.

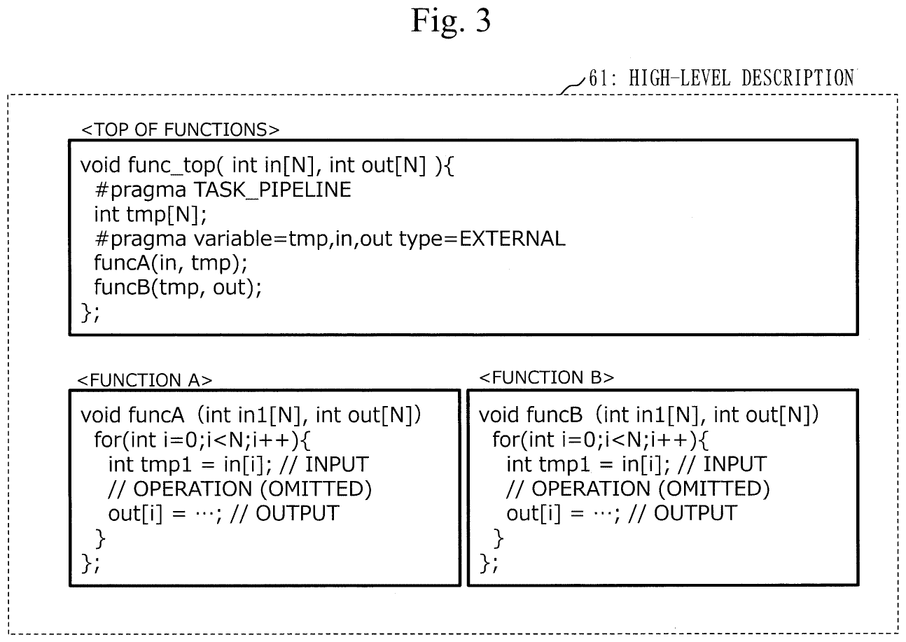

FIG. 3 is a diagram illustrating an example of the high-level description 61 according to this embodiment.

In FIG. 3, a C++ program is presented as the high-level description 61. In the example of the high-level description 61 in FIG. 3, funcA and funcB that operate in parallel are described. It is also described that each of funcA and funcB accesses the external memory.

### <<Access Variable Extraction Process>>

In step S102, the access variable extraction unit 111 extracts a plurality of external memory access variables that correspond to the plurality of external memory accesses from the high-level description 61. The access variable extraction unit 111 identifies a directive such as pragma or a description such a separate input file, and extracts variables that correspond to the external memory as external memory access variables.

The access variable extraction unit 111 also analyzes an access pattern of array variables. The access pattern of array variables is information indicating whether the index of the array variables is sequential or random, for example. The access pattern of the array variables is used in the calculation of required performance in an access requirement determination process to be described later.

The above will be described using the example in FIG. 3.

The access variable extraction unit 111 extracts “#pragma variable=tmp,in,out type=EXTERNAL” from “func_top” in the C++ program in FIG. 3. Through this, the access variable extraction unit 111 extracts that tmp, in, and out are external memory access variables.

### <<Access Requirement Determination Process>>

In step S103, the access requirement determination unit 112 determines a minimum requirement 70 for a variable memory access circuit 701, which is a memory access circuit of each of the plurality of external memory access variables.

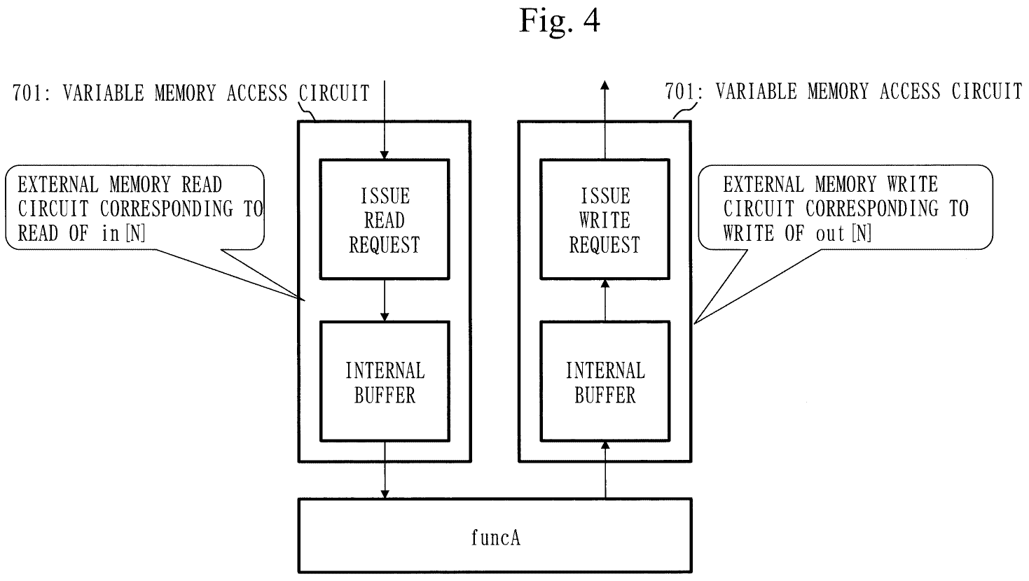

FIG. 4 is a diagram illustrating an example of the variable memory access circuit 701 according to this embodiment.

Note that funcA in FIG. 3 is the module shown in FIG. 4. The variable memory access circuit 701 is a memory access circuit for each external memory access variable.

In FIG. 4, the variable memory access circuit 701 of an external memory access variable “in[N]” is an external memory read circuit. The variable memory access circuit 701 of an external memory access variable “out[N]” is an external memory write circuit.

In the access requirement determination process, the minimum requirement 70 for each variable memory access circuit of the external memory read circuit of in[N] and the external memory write circuit of out[N] is determined in funcA. The same also applies to funcB.

The minimum requirement 70 is parameters of the variable memory access circuit 701 that allow the variable memory access circuit 701 to satisfy required module performance, which is required performance of the module, and allow the circuit scale of the variable memory access circuit 701 to be smaller than a predetermined scale. The access requirement determination unit 112 may determine a plurality of minimum requirements as the minimum requirement 70.

Specifically, the minimum requirement 70 is a burst length, the number of concurrent issues, and an internal buffer size in the variable memory access circuit 701. Specifically, the access requirement determination process involves the following.

The access requirement determination unit 112 determines the minimum requirement 70 of the variable memory access circuit 701 for each external memory access variable extracted in step S101, using as input the high-level description 61 and the external memory information 64.

The external memory information 64 includes the following information.

(1) Memory and bus specifications: bus width, maximum burst length, maximum number of concurrent issues
(2) Performance: latency of the external memory for each access size as seen from an external bus of this circuit.

The access size is the unit of a single request as seen from the external memory. When seen from the variable memory access circuit, the access size is a transfer unit (burst length×bus width), and the transfer unit and the access size are synonymous in the following.

The minimum requirement 70 of the variable memory access circuit 701 for each external memory access variable is parameters of the variable memory access circuit 701 that allow the required module performance to be satisfied and allow the circuit scale to be smaller than a predetermined scale. The circuit design assistance device 100 may store a threshold for the circuit scale, and the access requirement determination unit 112 may determine a plurality of sets of parameters of the variable memory access circuit 701 that result in a circuit scale smaller than the threshold. Alternatively, the access requirement determination unit 112 may determine a single set of parameters for the variable memory access circuit 701 that minimizes the circuit scale.

Specifically, the parameters of the variable memory access circuit 701 determined as the minimum requirement 70 are a burst length, the number of concurrent issues, and an internal buffer size. The internal buffer size may be the number of internal buffers.

The access requirement determination unit 112 determines the minimum requirement for in[N] as follows. The same calculation is performed also for out[N] and funcB.

(a) The processing time of funcA when in[N] is replaced with an internal memory (minimum memory read latency of 1 [cycle]) is calculated as the required latency of the module. This required latency of the module is the required module performance.

(b) The required throughput of in[N] is calculated based on the following formula. The required throughput of in[N] is also called the required read throughput.

Required throughput=number of array elements of in (N)×type size of in (4 [bytes])÷processing time calculated in (a)

(c) The number of concurrent issues and a burst length that satisfy the following formula are determined based on the required throughput calculated in (b) and the external memory information 64 (bus width, maximum burst length, latency per transfer unit, etc.).

Required throughput [bps]≤maximum throughput [bps] of the memory access circuit=(burst length×bus width×number of concurrent issues) [bit]÷latency per transfer unit (burst length×bus width) [s]

In the formula (c), “maximum throughput of the memory access circuit [bps]” is the throughput of the variable memory access circuit of the minimum requirement that is determined based on the burst length, bus width, number of concurrent issues, and transfer unit that satisfy the required throughput calculated based on (2) of the external memory information described above.

A method for calculating in a case where the bus width and the required throughput are the following is indicated below.
Bus width: 64 bits
Required throughput: 1.0 [Gbps]

Based on the formula (c), combinations of the number of concurrent issues and the burst length that satisfy the required throughput are as follows.
Burst length 4× number of concurrent issues 3:1.92 [Gbps], required buffer size: 768 bits
Burst length 8× number of concurrent issues 2:1.70 [Gbps], required buffer size: 1,024 bits
Burst length 16× number of concurrent issues 1:1.28 [Gbps], required buffer size: 1,024 bits

The required buffer size is calculated using the following formula.

Required buffer size=burst length×bus width×number of concurrent issues

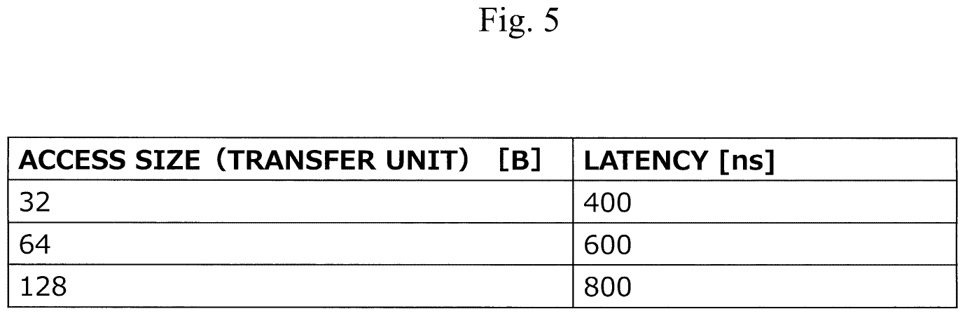

FIG. 5 is a diagram illustrating the latency of the external memory for each access size (or for each burst length in the case of a fixed bus width) according to this embodiment.

As indicated in FIG. 5, the latency of the external memory for each access size (or for each burst length in the case of a fixed bus width) is defined as (2) of the external memory information. Then, by substituting this latency [ns] into “latency per transfer unit (burst length× bus width) [s]” in the formula (c) above, the maximum throughput of the variable memory access circuit can be calculated.

### <<Parallel Access Identification Process>>

In step S104, the parallel access identification unit 113 creates a data flow 71 including flows of a plurality of external memory accesses based on the minimum requirement 70 and the high-level description 61, and identifies external memory accesses that operate in parallel. The parallel access identification unit 113 uses as input the minimum requirement 70 of each variable memory access circuit extracted in step S102 and the high-level description 61. Then, the parallel access identification unit 113 creates a data flow including flows of external memory accesses, and identifies external memory accesses that operate in parallel.

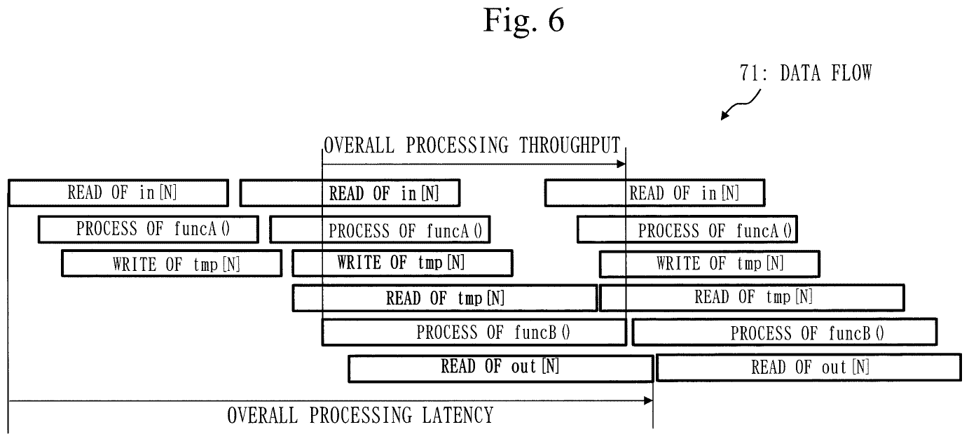

FIG. 6 is a diagram illustrating an example of a data flow according to this embodiment.

FIG. 6 is a diagram in which data flows of funcA, funcB, and their variable memory access circuits 701 are extracted. The data flows of funcA, funcB, and their variable memory access circuits 701 result in a pipeline operation as shown in FIG. 6. The parallel access identification process is performed by a process equivalent to general data flow analysis.

In FIG. 6, the read of in[N], the read of tmp [N], the write of tmp [N], and the write of out[N] that are depicted in bold concurrently access the external memory. The parallel access identification unit 113 extracts a section where these accesses overlap as a parallel access section.

The parallel access identification unit 113 identifies the read of in[N], the read of tmp [N], the write of tmp [N], and the write of out[N] that concurrently access the external memory as the external memory accesses that operate in parallel.

### <<Order Determination Process>>

In step S105, the order determination unit 114 uses the minimum requirement 70 to determine the issue order 72 of the external memory accesses that operate in parallel identified in step S104 so as to satisfy the required circuit performance 63. The required circuit performance 63 is the required performance of the overall processing of the circuit to be designed, and is the latency and throughput of the overall processing. If the external memory accesses that operate in parallel and are issued in the determined issue order 72 do not satisfy the required circuit performance 63, the order determination unit 114 determines a different issue order so as to satisfy the required circuit performance 63.

Specifically, the order determination unit 114 uses the minimum requirement 70 as initial values, and determines parameters of each of the variable memory access circuits of the external memory accesses that operate in parallel and the issue order 72 of the external memory accesses that operate in parallel so as to satisfy the required circuit performance 63. If the required circuit performance 63 is not satisfied, the order determination unit 114 changes the parameters (number of concurrent issues, burst length) of the variable memory access circuit so as to search for parameters that allow the required circuit performance 63 to be satisfied, and determines the issue order 72. In other words, if the required circuit performance 63 is not satisfied, the order determination unit 114 determines different parameters and issue order so as to satisfy the required circuit performance 63.

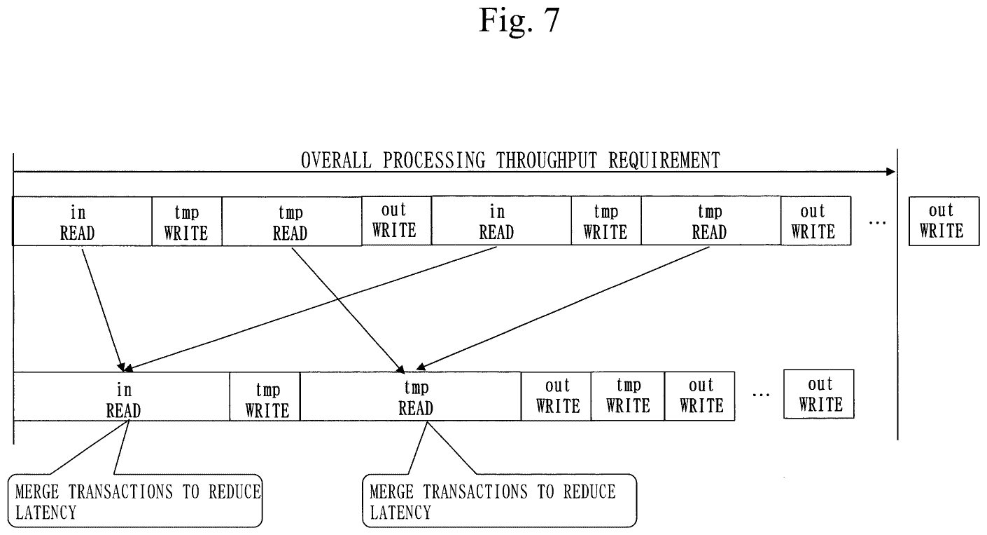

FIG. 7 is a diagram illustrating an example of the order determination process according to this embodiment.

The order determination unit 114 uses as input the parallel access section identified in step S104 where the external memory accesses operate in parallel, the minimum requirement 70 of each variable memory access circuit extracted in step S103, and the required circuit performance 63. The order determination unit 114 determines the issue order 72 of transactions and external memory access specifications for each module.

For example, the order determination unit 114 determines the above using the following algorithm.

(A) The access requests from each variable memory access circuit are processed in a round-robin manner. The access requests after the round-robin processing are shown in the upper part of FIG. 7.

(B) If the required circuit performance 63 is satisfied at this point, the scheduling is terminated. If it is not satisfied, proceed to (C).

(C) The burst length and number of concurrent issues are changed so that consecutive access requests (transactions) are merged in order from ones with the longest processing latency with the parameters of the minimum requirement 70 so as to reduce the total latency.

(D) Return to (A) and repeat.

The above algorithm performs scheduling by utilizing the characteristic of a commonly used external memory, such as a DDR-SDRAM, that consecutive addresses result in smaller latency than in the case of random accesses.

The algorithm is not limited to the above, provided that an issue order, the number of concurrent issues of modules, and a burst length that satisfy the required performance can be obtained based on the same input (number of concurrent issues of the external memory access circuit, burst length, latency per transfer size of the external memory bus). For example, a general mathematical optimization algorithm or the like may be used.

The minimum requirement used as initial values may be determined in the access requirement determination process or may be determined in the parallel access identification process.

For example, the access requirement determination unit 112 determines a plurality of minimum requirements as the minimum requirement. Specifically, these are three minimum conditions derived from the above formula (c). Then, the parallel access identification unit 113 identifies external memory accesses that operate in parallel based on one minimum requirement of the plurality of minimum requirements and the high-level description. Then, the order determination unit 114 uses the specified one of the minimum requirements as initial values, and determines parameters of the variable memory access circuit and an issue order so as to satisfy the required circuit performance 63.

For example, the access requirement determination unit 112 may determine a plurality of minimum requirements as the minimum requirement, and may specify one minimum requirement out of the plurality of minimum requirements. Specifically, parameters that require the smallest buffer size may be selected from three minimum conditions derived from the above formula (c). Then, the order determination unit 114 uses the specified one of the minimum requirements as initial values, and determines parameters of the variable memory access circuit and an issue order so as to satisfy the required circuit performance 63.

### <Circuit Generation Process>

In step S106, the circuit generation unit 120 generates the circuit description 65 for an external memory access circuit including a scheduler circuit that issues the external memory accesses that operate in parallel in the issue order 72.

The circuit generation unit 120 generates an external memory access circuit 702 (a scheduler, a transfer control unit, an internal buffer) based on the determined issue order of external memory accesses (addresses), number of concurrent issues, burst length, and internal buffer specifications.

The circuit description is generated, for example, by storing IP in which the above parameters (the issue order of external memory accesses (addresses), the number of concurrent issues, the burst length, the internal buffer specifications) can be changed in a database. IP is an abbreviation for intellectual property.

The circuit description is written in a circuit representation, such as a high-level description or an RTL description.

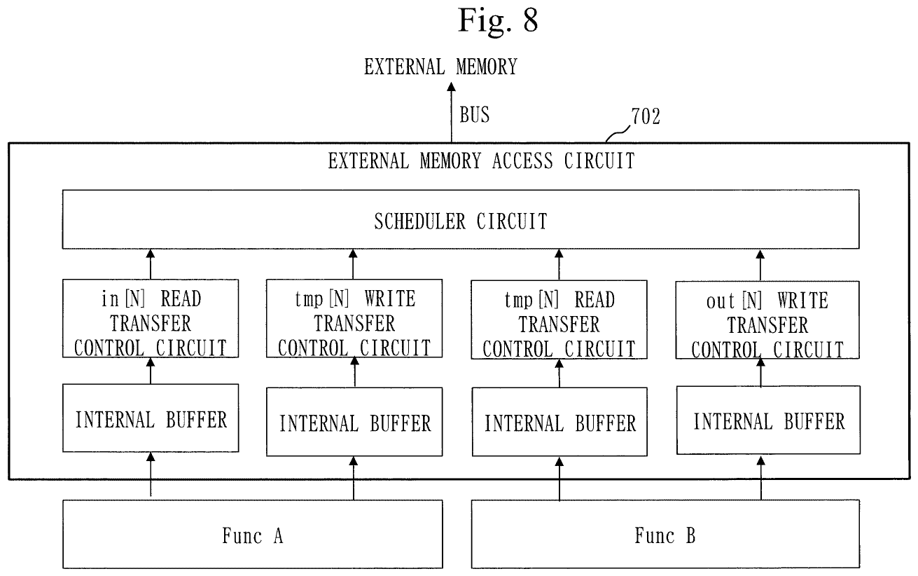

FIG. 8 is a diagram illustrating an example of the external memory access circuit 702 generated by the circuit generation unit according to this embodiment.

The circuit generation unit 120 generates the external memory access circuit 702 that includes the following.
(1) A scheduler circuit that controls the access issue order determined in step S105
(2) A transfer control circuit according to the number of concurrent issues of read and write requests of the external memory access variables, the bust length, and the bus width determined in step S105
(3) Δn internal buffer that can hold data of the number of concurrent issues×the burst length× the bus width above.

By connecting the external memory access circuit 702 generated by the circuit generation unit with funcA and funcB generated from the high-level description 61, a circuit having a configuration as shown in FIG. 8 is generated.

### ***Other Configurations***

### <Variation 1>

In this embodiment, the functions of the scheduling unit 110 and the circuit generation unit 120 are realized by software. As a variation, the functions of the scheduling unit 110 and the circuit generation unit 120 may be realized by hardware.

Specifically, the circuit design assistance device 100 includes an electronic circuit 909 in place of the processor 910.

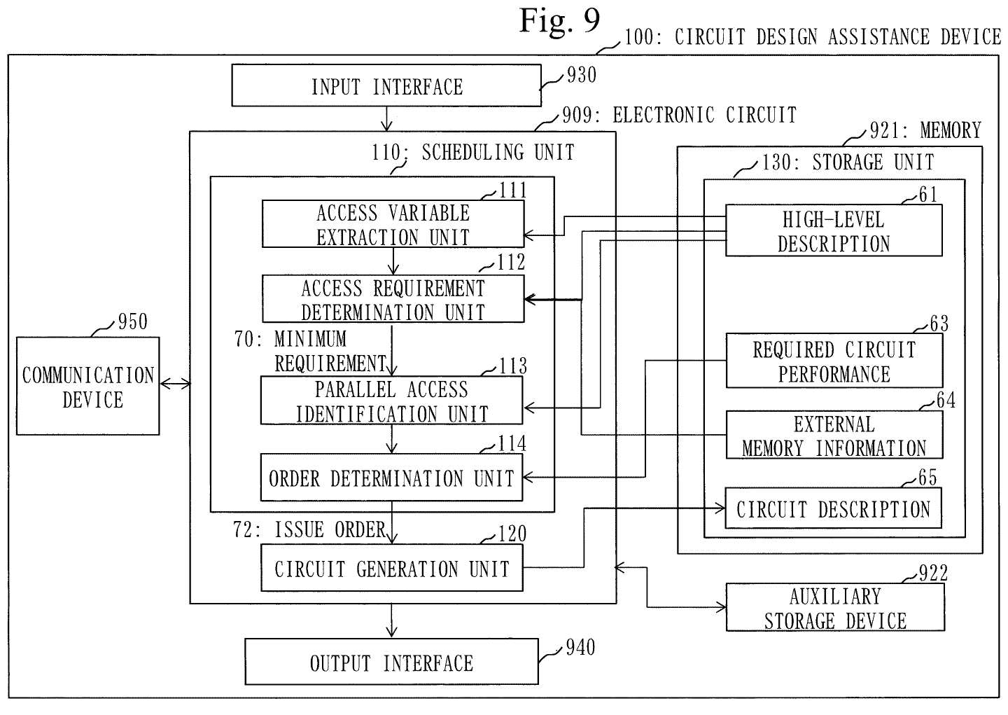

FIG. 9 is a diagram illustrating an example of the configuration of the circuit design assistance device 100 according to a variation of this embodiment.

The electronic circuit 909 is a dedicated electronic circuit that realizes the functions of the scheduling unit 110 and the circuit generation unit 120. Specifically, the electronic circuit 909 is a single circuit, a composite circuit, a programmed processor, parallel-programmed processors, a logic IC, a GA, an ASIC, or an FPGA. GA is an abbreviation for gate array. ASIC is an abbreviation for application specific integrated circuit. FPGA is an abbreviation for field-programmable gate array.

The functions of the scheduling unit 110 and the circuit generation unit 120 may be realized by one electronic circuit, or may be distributed among and realized by a plurality of electronic circuits.

As another variation, part of the functions of the scheduling unit 110 and the circuit generation unit 120 may be realized by an electronic circuit, and the remaining functions may be realized by software. Part or all of the functions of the scheduling unit 110 and the circuit generation unit 120 may be realized by firmware.

Each of the processor and the electronic circuit is also referred to as processing circuitry. That is, the functions of the scheduling unit 110 and the circuit generation unit 120 are realized by the processing circuitry.

### Description of Effects of this Embodiment

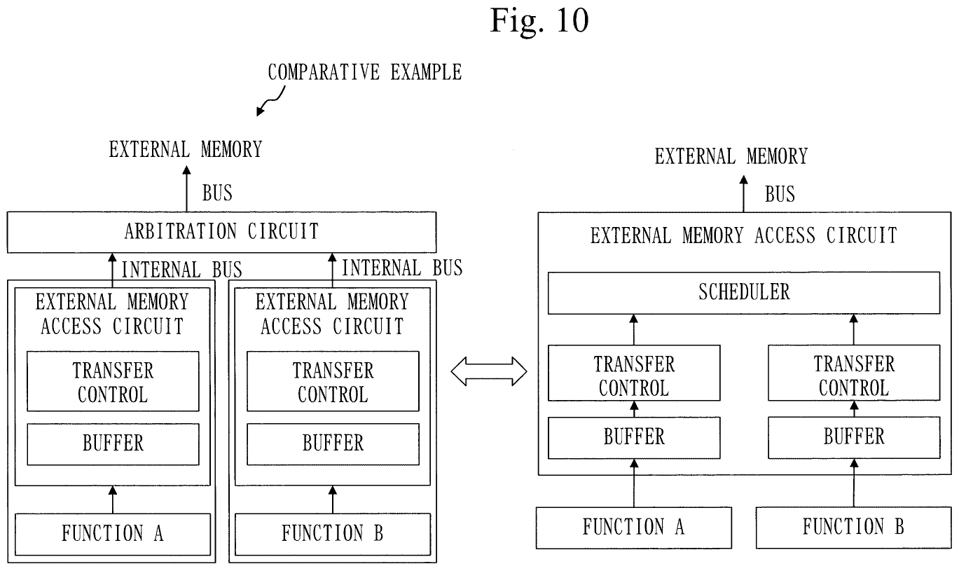

FIG. 10 is a diagram illustrating a comparative example of the circuit design assistance device 100 according to this embodiment.

In FIG. 10, the right diagram shows the circuit to be designed in the circuit design assistance device 100 according to this embodiment, and the left diagram shows a circuit of the comparative example for comparison with this embodiment.

In the comparative example, there is a need to design (specify) an arbitration circuit manually. On the other hand, in the right diagram, a scheduler can be automatically generated from the external memory access requirements of the functions A and B.

In the comparative example, for example, the transfer control and buffer specifications are determined based on the access pattern of each function. Moreover, when the arbitration circuit is manually determined, it is not possible to change the transfer control (number of concurrent issues, burst length) and the internal buffer size in the external memory access circuit based on arbitration specifications. On the other hand, in the right diagram, the transfer control and buffer specifications for each function can be generated based on scheduling results that take into account both the functions A and B.

As described above, with the circuit design assistance device 100 according to this embodiment, it is possible to achieve performance closer to the required performance by automatically generating a scheduler circuit based on performance information of an external memory.

Furthermore, with the circuit design assistance device 100 according to this embodiment, transfer control, an internal buffer and a scheduler are generated according to scheduling results, so that performance can be enhanced and a circuit with high external memory utilization can be obtained.

In Embodiment 1 above, each unit of the circuit design assistance device is described as an independent functional block. However, the configuration of the circuit design assistance device may differ from the configuration in the embodiment described above. The functional blocks of the circuit design assistance device may have any configuration, provided that the functions described in the above embodiment can be realized. The circuit design assistance device may be a system composed of a plurality of devices, instead of a single device.

Two or more parts of Embodiment 1 may be implemented in combination. Alternatively, one part of this embodiment may be implemented. This embodiment may be implemented partially or as a whole in any combination.

That is, in Embodiment 1, each embodiment can be freely combined, or any constituent element of each embodiment may be modified. Alternatively, any constituent element can be omitted in each embodiment.

The embodiment described above is essentially a preferable example, and is not intended to limit the scope of the present disclosure, the scope of applications of the present disclosure, and the scope of uses of the present disclosure. The embodiment described above can be modified in various ways as necessary. For example, a procedure described using a flowchart or a sequence diagram may be appropriately modified.

### REFERENCE SIGNS LIST

61: high-level description; 63: required circuit performance; 64: external memory information; 65: circuit description; 70: minimum requirement; 71: data flow; 72: issue order; 100: circuit design assistance device; 110: scheduling unit; 111: access variable extraction unit; 112: access requirement determination unit; 113: parallel access identification unit; 114: order determination unit; 120: circuit generation unit; 130: storage unit; 701: variable memory access circuit; 702: external memory access circuit; 909: electronic circuit; 910: processor; 921: memory; 922: auxiliary storage device; 930: input interface; 940: output interface; 950: communication device.

1. A circuit design assistance device to assist in designing a circuit, the circuit design assistance device comprising
processing circuitry to:
identify external memory accesses that operate in parallel in the circuit based on a high-level description describing the circuit in a high-level language and including a plurality of external memory accesses indicating accesses to an external memory from a plurality of modules, required circuit performance, which is required performance of the circuit, and external memory information including specifications and performance of the external memory, and determine an issue order of the external memory accesses that operate in parallel so as to allow performance of the circuit to satisfy the required circuit performance; and
generate a circuit description of an external memory access circuit including a scheduler circuit that issues the external memory accesses that operate in parallel in the issue order.

2. The circuit design assistance device according to claim 1,
wherein when the external memory accesses that operate in parallel and are issued in the issue order do not satisfy the required circuit performance, the processing circuitry determines another issue order so as to satisfy the required circuit performance.

3. The circuit design assistance device according to claim 2,
wherein the processing circuitry extracts a plurality of external memory access variables corresponding to the plurality of external memory accesses from the high-level description,
wherein the processing circuitry determines a minimum requirement for a variable memory access circuit, which is a memory access circuit of each of the plurality of external memory access variables, the minimum requirement being a parameter of the variable memory access circuit that allows required performance of a module corresponding to the variable memory access circuit to be satisfied and allows a circuit scale of the variable memory access circuit to be smaller than a predetermined scale,
wherein the processing circuitry creates a data flow including flows of the plurality of external memory accesses based on the minimum requirement and the high-level description, and identifies the external memory accesses that operate in parallel, and
wherein the processing circuitry uses the minimum requirement as an initial value, and determines a parameter of the variable memory access circuit of each of the external memory accesses that operate in parallel and the issue order so as to satisfy the required circuit performance.

4. The circuit design assistance device according to claim 3,
wherein the processing circuitry determines a plurality of minimum requirements as the minimum requirement,
wherein the processing circuitry identifies the external memory accesses that operate in parallel based on one minimum requirement of the plurality of minimum requirements and the high-level description, and
wherein the processing circuitry uses the one minimum requirement as an initial value, and determines a parameter of the variable memory access circuit of each of the external memory accesses that operate in parallel and the issue order so as to satisfy the required circuit performance.

5. The circuit design assistance device according to claim 3,
wherein the processing circuitry determines a plurality of minimum requirements as the minimum requirement, and specifies one minimum requirement out of the plurality of minimum requirements, and
wherein the processing circuitry uses the one minimum requirement as an initial value, and determines a parameter of the variable memory access circuit of each of the external memory accesses that operate in parallel and the issue order so as to satisfy the required circuit performance.

6. The circuit design assistance device according to claim 3,
wherein when the parameter and the issue order that have been determined fail to satisfy the required circuit performance, the processing circuitry determines another parameter and another issue order so as to satisfy the required circuit performance.

7. The circuit design assistance device according to claim 4,
wherein when the parameter and the issue order that have been determined fail to satisfy the required circuit performance, the processing circuitry determines another parameter and another issue order so as to satisfy the required circuit performance.

8. The circuit design assistance device according to claim 5,
wherein when the parameter and the issue order that have been determined fail to satisfy the required circuit performance, the processing circuitry determines another parameter and another issue order so as to satisfy the required circuit performance.

9. The circuit design assistance device according to claim 3,
wherein as the minimum requirement, the processing circuitry determines a burst length, the number of concurrent issues, and an internal buffer size in the variable memory access circuit.

10. The circuit design assistance device according to claim 4,
wherein as the minimum requirement, the processing circuitry determines a burst length, the number of concurrent issues, and an internal buffer size in the variable memory access circuit.

11. The circuit design assistance device according to claim 5,
wherein as the minimum requirement, the processing circuitry determines a burst length, the number of concurrent issues, and an internal buffer size in the variable memory access circuit.

12. The circuit design assistance device according to claim 6,
wherein as the minimum requirement, the processing circuitry determines a burst length, the number of concurrent issues, and an internal buffer size in the variable memory access circuit.

13. The circuit design assistance device according to claim 7,
wherein as the minimum requirement, the processing circuitry determines a burst length, the number of concurrent issues, and an internal buffer size in the variable memory access circuit.

14. The circuit design assistance device according to claim 8,
wherein as the minimum requirement, the processing circuitry determines a burst length, the number of concurrent issues, and an internal buffer size in the variable memory access circuit.

15. A circuit design assistance method used for a circuit design assistance device that assists in designing a circuit, the circuit design assistance method comprising:
identifying external memory accesses that operate in parallel in the circuit based on a high-level description describing the circuit in a high-level language and including a plurality of external memory accesses indicating accesses to an external memory from a plurality of modules, required circuit performance, which is required performance of the circuit, and external memory information including specifications and performance of the external memory, and determining an issue order of the external memory accesses that operate in parallel so as to allow performance of the circuit to satisfy the required circuit performance; and
generating a circuit description of an external memory access circuit including a scheduler circuit that issues the external memory accesses that operate in parallel in the issue order.

16. A non-transitory computer readable medium storing a circuit design assistance program used for a circuit design assistance device that assists in designing a circuit, the circuit design assistance program causing a computer to execute:
a scheduling process of identifying external memory accesses that operate in parallel in the circuit based on a high-level description describing the circuit in a high-level language and including a plurality of external memory accesses indicating accesses to an external memory from a plurality of modules, required circuit performance, which is required performance of the circuit, and external memory information including specifications and performance of the external memory, and determining an issue order of the external memory accesses that operate in parallel so as to allow performance of the circuit to satisfy the required circuit performance; and
a circuit generation process of generating a circuit description of an external memory access circuit including a scheduler circuit that issues the external memory accesses that operate in parallel in the issue order.
